(19) United States
(12) Patent Application Publication
(10) Pub. No.: US 2019/0380304 A1
(43) Pub. Date: Dec. 19, 2019

(54) ADJUSTABLE HEIGHT PET FEEDING APPARATUS

(71) Applicant: Roberta D. Batts, Brentwood, NY (US)

(72) Inventor: Roberta D. Batts, Brentwood, NY (US)

(21) Appl. No.: 16/006,919

(22) Filed: Jun. 13, 2018

(51) Int. Cl. A01K 5/02; A01K 5/01; F16M 11/38

(52) U.S. Cl. CPC A01K 5/0291; F16M 11/38; A01K 5/0114

(57) ABSTRACT

Embodiments are described for a hydraulically operated pet feeding apparatus with a releasably attached feeding tray. A base structure is mechanically connected to a hydraulic left which extend from a collapsed feeding position to a desired leading height to enable a variety of users to lead/unload a plurality of feeding/watering bowls and return to the collapsed feeding position using a remotely operated lift control switch enabling the lift and feeding tray to transition a collapsed and extended position. The feeding tray is releasably attached to the top portion of the hydraulic lift using a latch and further includes to cylindrically-sped cutouts and further includes at least two cylindrically shaped apertures to mount a feeding and water bowl a

### FIELD

The embodiments presented relate to feeding apparatus, and in particular, to hydraulically operated feeding apparatus which enables a variety of heights.

### BACKGROUND

Many pet feeding devices and apparatus require pet owners and users to bend over and access the feeding tray located along the floor often spilling many of the remaining contents. However, these current systems and designs are impractical for those pet owners who are immobile, have a physical disability, or elderly and unable to access the pet food bowl.

In the current arts, some pet feeders have a removable handle with one end configured to releasably engage with the feeding container and another end for grasping. While helpful, these devices may pose a problem for a user that has limited movement or impaired visibility.

U.S. Pat. No. 9,644,786 to Christine E. Steiner discloses a pet feeder having a pneumatic lifting system with a rotatable mounted feeding tray. A support structure has an end connected to a surface of a feeding tray located opposite another end connected to a retaining structure. A capturing structure is connected to a cylinder. The capturing structure has an upper capturing portion having a primary opening located opposite a lower capturing portion having a secondary opening. The upper capturing portion has a primary retaining lip and the lower capturing portion has a secondary retaining lip forming a track. The retaining structure is retained within the capturing structure. The retaining structure is configured to travel along the track of the capturing structure and to rotate the tray around the perimeter of the cylinder. The pet feeder can have audio capabilities, a programmable timer, a feeding alert system, and a removable tray.

While the Steiner patent solves a similar problem to the invention described herein, the Steiner patent discloses the use of a pneumatic double actuating cylinder. It is believed that a more elegant solution is desired in the current arts which provides a simple, cost-efficient solution for a pet feeding apparatus.

It can be seen that an improvement in the arts surrounding pet feeding trays is warranted. One such advance is provided in the various embodiments described herein.

### SUMMARY OF THE INVENTION

Embodiments described herein provide for an adjustable height feeding apparatus having a rectangular shaped base portion including a set of linear tracks extending a length of the base portion to adjust a height of a feeding tray to a desired position between a collapsed and raised position. The raised position allows a user to access a set of tray bowls wherein the user may input a foodstuff, liquid, medicine, or other consumable item for their pet. The apparatus also has a wirelessly enabled scissor lift in electrical communication with a motor which enables a plurality of slide wheels to traverse along the set of linear tracks to adjust the height of a feed tray. The feeding tray is releasably attached at the second end of the scissor lift using an attachment mechanism and also includes a set of dimensioned apertures to house at least one tray bowl.

In one aspect, the apparatus includes a foot pedal switch configured to energize and de-energize the motor. The foot pedal may be especially useful for a user with extremely limited movement.

The motor is in communication with a bi-directional threaded rod in mechanical communication with a motor belt to cause rotation of the threaded rod to cause the height of the scissor lift to change. The bi-directional threaded rod is threaded through a cross member at the first end of the scissor lift.

In another aspect, the scissor lift is contained between the feeding tray and the base in the collapsed configuration.

In various embodiments, the apparatus is in communication with a programmable alert system and/or a programmable timer system. A memory component stores data that may be related to, but is not limited to, feed times, feed amounts, alerts, and medicine dosing.

In an aspect, the top portion is comprised of at least one aperture oriented to align with the apertures of the tray. Each aperture then at least partially receives tray bowl to retain the bowl therein. Each tray bowl has a rim about the top perimeter. The rim has a diameter greater than the diameter of the aperture such that the rim allows the bowl to rest atop the tray.

Other aspects and advantages of the present invention will be apparent from the following detailed description of the various embodiments and the accompanying drawings.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a perspective view of the adjustable height pet feeding apparatus, according to an embodiment of the present invention;

FIG. 2 illustrates a view of the apparatus in the collapsed configuration, according to an embodiment of the present invention;

FIG. 3 illustrates an exploded view of the apparatus, according to an embodiment of the present invention;

FIG. 4 illustrates a view of the apparatus in the lifted configuration, according to an embodiment of the present invention;

FIG. 5 illustrates a view of the apparatus in a partial lifted configuration, according to an embodiment of the present invention;

FIG. 6 illustrates a view of the apparatus and a user engaging with a foot pedal controller, according to an embodiment of the present invention;

FIG. 7 illustrates a view of the apparatus in a collapsed configuration, according to an embodiment of the present invention; and

FIG. 8 illustrates a block diagram of programmable components of the apparatus, according to an embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom.

Any reference to “invention” within this document is a reference to an embodiment of a family of inventions, with no single embodiment including features that are necessarily included in all embodiments, unless otherwise stated. Furthermore, although there may be references to “advantage's” provided by some embodiments, other embodiments may not include those same advantages, or may include different advantages. Any advantages described herein are not to be construed as limiting to any of the claims.

Before describing in detail exemplary embodiments, it is noted that the embodiments reside primarily in combinations of components related to the system. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

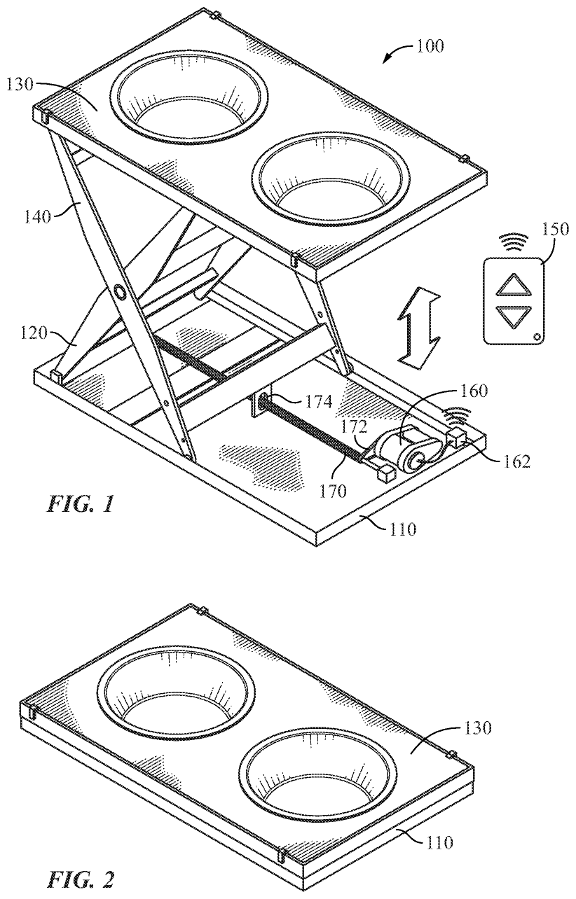

FIG. 1 illustrates a perspective view of the adjustable height pet feeding apparatus 100 which allows a variety of users to vertically lower and raise the apparatus to access the bowl contents without having to bend over. The apparatus 100 includes a rectangular shaped base portion 110 affixed to a first end of a motor-controlled scissor lift 120 which enables a feeding tray 130 attached at the second end of the scissor lift 140 to transition between a collapsed and lifted position using a controller 150.

In an embodiment, the scissor lift 120 is configured to be in wireless communication with a controller 150. The controller 150 may be configured as a handheld unit with ON/OFF functionality, UP and DOWN functions to collapse and raise the apparatus, among other functions known in the arts. The wireless controller 150 wirelessly communicates instructions to the motor 160. The controller 150 is in wireless communication with a receiver 162 which is in operable communication with the motor.

One skilled in the arts may appreciate that the adjustable height pet feeding apparatus may be powered via a conventional 120V wall outlet, or by a local battery positioned on the base portion 110.

In one embodiment, the motor 160 effects a bi-directional threaded rod 170 in mechanical communication with a motor belt 172 to cause a rotation of the threaded rod 170. The threaded rod 172 is connected to each leg of the scissor lift 120 nearmost the first end. The threaded rod 170 may extend through a threaded opening 174 positioned on the first and second crossmembers 176, 178 of the scissor lift 120.

While many shapes and dimensions may be used for the tray 130 it is preferred that the tray be large enough to minimize spillage of the liquid or foodstuff while providing sufficient access by the animal.

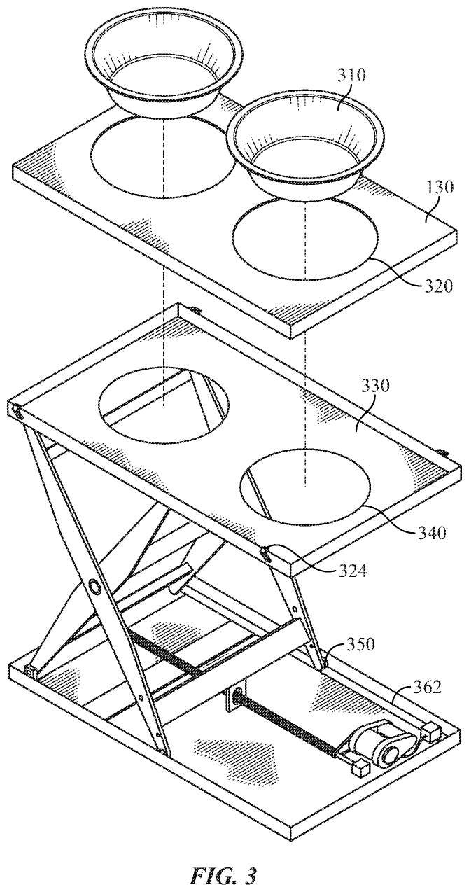

FIG. 2 illustrates the adjustable height pet feeding apparatus 100 in a collapsed configuration wherein the motor 160 and motor-associated components as well as the scissor lift 120 are contained between the base portion HO and feeding tray 130.

The scissor lift 120 is preferentially constructed to be operational in both the collapsed and raised positions, allowing a pet to feed as well as the filling and maintenance of the feeding tray 130 by a user. It may be desirable for the tray to stop at any position along the travel path of the scissor lift 120.

Now referring to FIG. 3, an exploded view of the adjustable height pet feeding apparatus is illustrated. While many alternate embodiments may exist, a preferred embodiment is illustrated and described herein. A plurality of tray bowls 310 are positioned to each rest within a suitably dimensioned aperture 320. Each tray bowl 310 may include a rim 312 around the top perimeter. The rim 312 has a diameter larger than the diameter of the aperture 320 such that the rim rests on the top surface of the tray 130. The tray 130 rests atop a top portion 330 which includes similarly positioned and dimensioned apertures 340.

The tray 130 is removably engaged with the top portion 330 via a plurality of attachment members 324. The attachment members 324 may he provided as a pivoting clip, a snap, or similar means of affixing two surfaces known in the arts.

Preferentially, each tray bowl 310 may be releasably engaged with the tray 130 for cleaning, filling, or replacement. It is within the scope of the invention for tray 130 to have at least one compartment. The compartment can receive including, but not limited to, removable dinnerware or an item. An item includes, but is not limited to, food, a liquid, medicine, or dinnerware. It is also within the scope of this invention for the tray 130 to not have any openings or compartments, whereby, a surface of the tray 130 is configured to receive dinnerware including, but not limited to, a dish, a plate, a bowl, a pet food tray, a food serving dish, or a cup. In another embodiment, at least one opening is configured to receive removable dinnerware. In another embodiment, a plurality of openings such as tray opening 6A and tray opening 6B, are configured to receive removable dinnerware.

The scissor lift 120 includes a plurality of slide wheels 350 which traverse along a set of linear tracks 362 to adjust the height of the apparatus 100. In a preferred embodiment, each linear track 362 is positioned on the inner side of the base portion 110.

The top portion 330 includes a raised ridge to fittingly receive the tray 130 by vertically lowering the tray 130 thereon. This prevents the tray from sliding, shifting, or disengaging with the top portion during use. Each attachment mechanism 324 is positioned on the outer side of the raised edge.

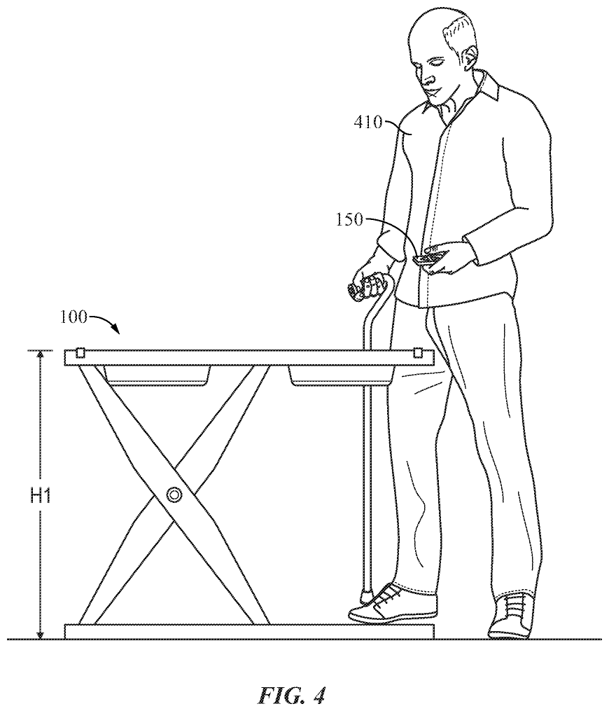

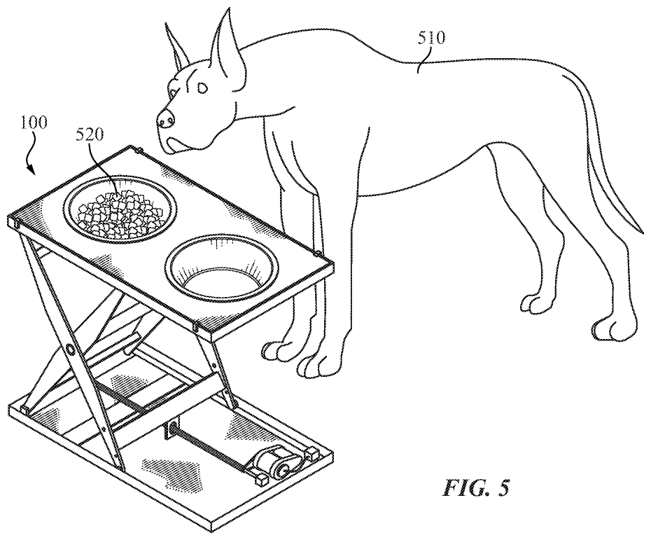

FIG. 4 illustrates a user 410 utilizing the controller 150. The apparatus 100 is illustrated in a raised configuration at a height H¹ such that the user 410 is not required to bend to reach the tray howls 310. Similarly, FIG. 5 illustrates a pet 510 and foodstuff 520 within the tray bowl 310. The pet 510 may feed while the apparatus is in a raised or collapsed position depending on the height or preference of the pet 510.

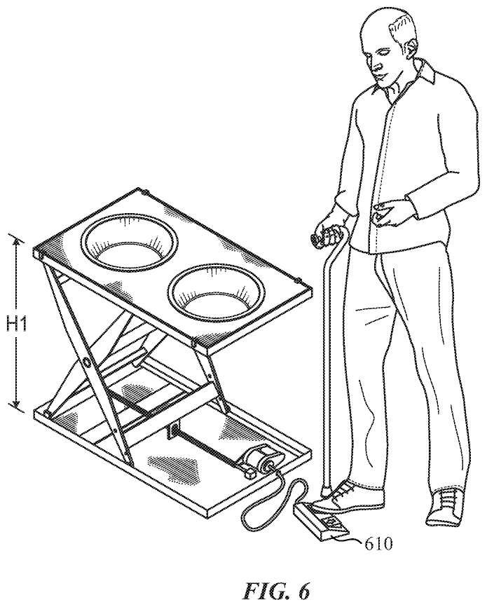

In reference to FIGS. 6 and 7, the adjustable height pet feeding apparatus 100 is shown having a foot pedal 610 in operable communication with the motor-controlled scissor lift 120. The foot pedal 610 operates my receiving a stimulus from the user such as an applied pressure via stepping on the pedal. Once a stimulus is received, the apparatus 100 transitions between the collapsed and raised positions.

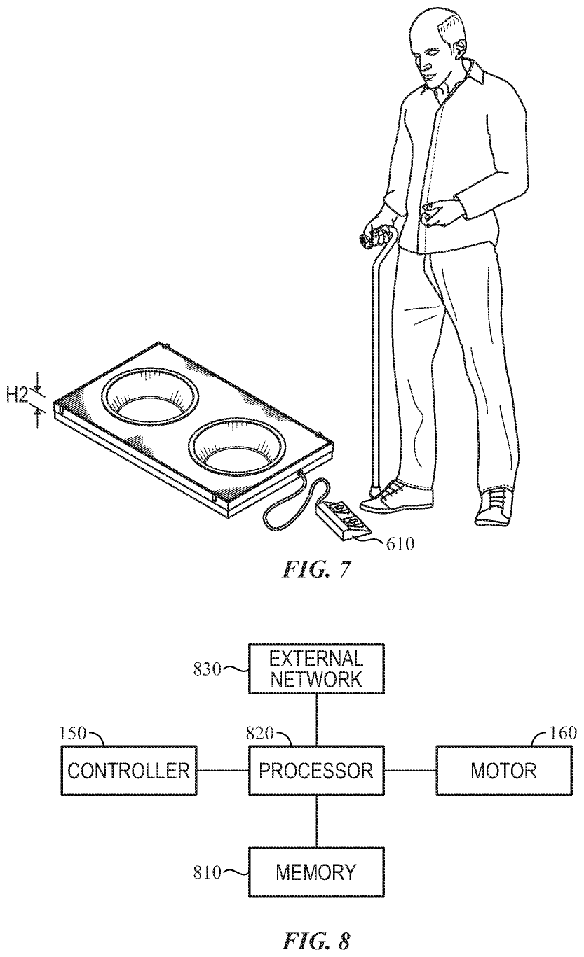

In reference to FIG. 8, the apparatus includes the controller 150 in communication with a memory component 810. The memory component 810 is in communication with a processor 820 configured to instruct the motor to perform a plurality of actions.

In an alternate embodiment, the processor 820 is in communication with an external network 830 which may include a smart phone or likewise computing device. In this manner, the user may send and receive data and instructions to and from the apparatus 100 at a remote location. To accomplish this, a Bluetooth device, or Wi-Fi connection may be utilized.

In an alternate embodiment, the feeding tray 130 includes a pressure sensor configured to analyze the weight of the container. During use, the pet feeding tray 130 may he raised or collapsed dependent on the pressure sensed from the presence or lack of foodstuff 520 in the tray bowl 310. In one example, the user raises the apparatus 100 to fill the tray bowl 310 before feeding a pet 510 (see FIG. 5). Once feeding is complete, the apparatus returns to a collapsed position when the weight of the food is no longer sensed by the pressure sensor. One skilled in the arts may appreciate that a similar method may be utilized for an automated water bowl.

Additional objects include, but are not limited to, the provision of the adjustable height pet feeder apparatus 100 to be otherwise remotely operated, to have audio capabilities, to have a food and water dispenser, to have a programmable timer, to have a programmable alert system, and to have wheels.

The tray 130 may constructed of plastic, wood, metal, composite, or other suitable material. In a preferred embodiment the tray 130 is constructed from a non-porous material to promote sanitation and facilitate cleaning thereof.

In an embodiment, the alert system, timer, and dispensing system are connected to the apparatus 100. Data including, but not limited to, pet feeding times, pet feeding quantities, and medicine dispensing times can be programmed into the alert system by a programmer. The programmer may include a machine or a user. It is within the scope of the invention to include an alert system wherein the user is notified during a programmed time with a recording, a sound, a light, or a series of flashing lights.

In an alternate embodiment, the tray 130 and each tray bowl 310 may be integrally molded to one another while being removably engaged with the top portion 330.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An adjustable height feeding apparatus, the apparatus comprising:
a rectangular shaped base portion including a set of linear tracks extending a length of the base portion to adjust a height of a feeding tray to a desired position between a collapsed and raised position to allow a user to access a set of tray bowls at a raised position;
a wirelessly enabled scissor lift in electrical communication with a motor which enable a plurality of slide wheels to traverse along the set of linear tracks to adjust the height of a feed tray attached at a second end, wherein the feeding tray is releasably attached at the second end of the scissor lift using an attachment mechanism and further including a set of dimensioned apertures to house at least one tray bowl.

2. The apparatus of claim 1, further including a foot pedal switch configured to energize/de-energize the motor.

3. The apparatus of claim 1, wherein the rectangular shaped base portion further includes a bi-directional threaded rod in mechanical communication with a motor belt to cause rotation of the threaded rod to cause the height of the scissor lift to change.

4. The apparatus of claim 3, wherein the bi-directional threaded rod is threaded through a cross member at the first end of the scissor lift.

5. The apparatus of claim 1, wherein the scissor lift is contained between the feeding tray and the base in the collapsed configuration.

6. The apparatus of claim 1, further comprising a programmable alert system.

7. The apparatus of claim 1, further comprising a programmable timer system.

8. The apparatus of claim 7, wherein the programmable timer system is in communication with an automated feeder.

9. The apparatus of claim 1, having a memory component configured to store a plurality of settings.

10. An adjustable height feeding apparatus, the apparatus comprising:
a rectangular shaped base portion including a set of linear tracks extending a length of the base portion to adjust a height of a feeding tray to a desired position between a collapsed and raised position to allow a user to access a set of tray bowls at a raised position;
a wirelessly enabled scissor lift in electrical communication with a motor which enable a plurality of slide wheels to traverse along the set of linear tracks to adjust the height of a feed tray attached at a second end, wherein the feeding tray is releasably attached to a top portion, wherein the top portion is attached at the second end of the scissor lift using an attachment mechanism and further including a set of dimensioned apertures to house at least one tray bowl.

11. The apparatus of claim 10, wherein the top portion is comprised of at least one aperture oriented to align with the at least one aperture of the tray.

12. The apparatus of claim 11, wherein the top portion apertures is dimensioned to at least partially receive the tray bowl.

13. The apparatus of claim 10, wherein each tray bowl has a rim positioned at the perimeter, wherein the rim has a greater diameter than the diameter of the aperture.

14. The apparatus of claim 10, The apparatus of claim 1, further including a foot pedal switch configured to energize/de-energize the motor.

15. The apparatus of claim 10, wherein the rectangular shaped base portion further includes a bi-directional threaded rod in mechanical communication with a motor belt to cause rotation of the threaded rod to cause the height of the scissor lift to change.

16. The apparatus of claim 15, wherein the bi-directional threaded rod is threaded through a cross member at the first end of the scissor lift.

17. The apparatus of claim 10, wherein the scissor lift is contained between the feeding tray and the base in the collapsed configuration.

18. The apparatus of claim 10, further comprising a programmable alert system.

19. The apparatus of claim 10, further comprising a programmable timer system.

20. The apparatus of claim 19, wherein the programmable timer system is in communication with an automated feeder.
